(19) United States
(12) Patent Application Publication
(10) Pub. No.: US 2025/0199597 A1
(43) Pub. Date: Jun. 19, 2025

(54) EFFICIENT ACTIVE IDLE POWER MANAGEMENT FOR COMPUTING SYSTEMS IN AN EFFICIENCY LATENCY CONTROL MODE

(71) Applicant: Intel Corporation, Santa Clara, CA (US)

(72) Inventors: Shruthi Venugopal, Austin, TX (US); Nikethan Shivanand Baligar, Hillsboro, OR (US); Rajesh Poornachandran, Portland, OR (US); Vivek Garg, Folsom, CA (US); Ujjwal Gupta, Chandler, AZ (US)

(21) Appl. No.: 18/541,976

(22) Filed: Dec. 15, 2023

(51) Int. Cl. G06F 1/3206; G06F 1/324

(52) U.S. Cl. CPC G06F 1/3206; G06F 1/324

(57) ABSTRACT

An apparatus includes: at least one core to execute instructions; an interface circuit coupled to the at least one core to perform non-processing operations and interface with one or more platform components; and a power controller coupled to the least one core and the interface circuit. The power controller is to receive at least one efficiency latency parameter to optimize a power-latency tradeoff and control a frequency of the interface circuit based at least in part on an activity level of the at least one core and the at least one efficiency latency parameter. Other embodiments are described and claimed.

### BACKGROUND

In modern processors, especially server-based processors, power management involves dynamic power distribution between cores, uncore circuitry, which includes an interconnect fabric that helps cores to be connected to additional components of the processor, interconnect and input/output (IO) circuitry for external communication. Most cloud service providers, to minimize system response time at all processor load levels including any 10 wake traffic, choose to set an operating system (OS) to use a performance-oriented processor power scheme, which constrains core and uncore frequencies at or near top speed, precluding any power savings associated with lower performance states.

In some cases, the providers disable low power states (such as Core C6 and Package C1E states of an Advanced Configuration and Power Interface (ACPI) scheme) in order to improve performance and responsiveness, at the expense of higher power, leading to higher operating expenses (e.g., measured as total cost of ownership (TCO)). When a system is idle under such conditions, it is referred to as “Performance Idle” or “Perf Idle.” The lower the “Performance Idle” power, the better it is in terms of effective performance/power/dollar (e.g., TCO).

### BRIEF DESCRIPTION OF THE DRAWINGS

FIG. 1 is a block diagram of a processor in accordance with an embodiment.

FIG. 2 is a flow diagram of a method in accordance with an embodiment.

FIG. 3 is a block diagram of a high-level system architecture in accordance with an embodiment.

FIG. 4 is a block diagram of a generative adversarial network in accordance with an embodiment.

FIG. 5 is a flow diagram of a method in accordance with another embodiment.

FIG. 6 is a flow diagram of a method in accordance with yet another embodiment.

FIG. 7 illustrates an example computing system.

FIG. 8 illustrates a block diagram of an example processor in accordance with an embodiment.

FIG. 9 is a block diagram of a processor core in accordance with an embodiment.

### DETAILED DESCRIPTION

In various embodiments, a variety of different processors, generally referred to herein as XPUs (processing units having different architectures), and including central processing units (CPU), graphics processing units (GPUs), accelerator processing units (APUs) and so forth, can be configured with efficient active idle power management using efficiency latency control (ELC) as described herein. Such processors may be especially suitable for use in datacenter implementations, such as may be configured in a wide variety of servers and other datacenter systems. Embodiments may be scalable from CPUs to XPUs at a platform level to provide power efficiency across a variety of utilization points (e.g., improved loadline linearity) across various stock keeping units (SKUs) of XPUs, to meet efficiency targets while minimizing the impact on system response time.

Techniques are provided to optimize a system for idle power savings or latency or both. In this way, users such as administrators of a datacenter can configure a system for power saving settings that meet their subscriber license agreements (SLAs). Embodiments may dynamically control a system in this manner, based at least in part on activity information regarding one or more cores and uncore of a CPU/XPU. Embodiments also enable a user to optimize power/latency at specific regions of a loadline, at an XPU level, a system level, and/or at a cluster of systems (i.e., fleet level).

In various embodiments, a processor can expose one or more user-configurable settings, referred to herein as efficiency latency parameters, that a user can set to indicate a desired tradeoff between efficiency (e.g., in terms of power consumption) and performance (e.g., in terms of latency). In one or more embodiments, these settings can be communicated to a processor via a memory mapped input output (MMIO) register interface.

With this arrangement, embodiments provide an approach to tradeoff power vs. latency and improve loadline linearity across different SKUs and generations of processors. In this way, user efficiency requirements can be met while providing an option to pick an impact on system response time. This is particularly so, as some users disable certain low power states (e.g., Core C6 and Package C1E states) but allow other low power states (e.g., Core C1E). Power consumption when a system is idle under such conditions is referred to as performance idle or “Perf Idle.” With embodiments, such idle conditions can be anticipated via the mechanisms described herein, as well as anticipating a low latency response situation under high utilization.

In one or more embodiments, Perf Idle identification is based on low uncore activity and/or core activity (such as low C0 residency on all the cores). Embodiments provide a software interface to the user to offer flexibility to program minimum fabric frequency (e.g., a frequency floor) while in the Perf Idle condition to meet power/performance criteria. The user can also configure the amount of utilization that contributes to the idle condition. This infrastructure makes it possible to achieve maximum performance more efficiently, at the cost of some added latency at lower load levels. Embodiments also cater to low latency responses while running at high utilization scenarios making optimal power efficiency vs. latency tradeoff.

In a particular implementation, there can be three or more control parameters or knobs available to a user: (1) EFFICIENCY_LATENCY_CTRL_RATIO, to be used to indicate an uncore frequency (e.g., a ratio with respect to core frequency) while in the ELC mode; (2) EFFICIENCY_LATENCY_CTRL_LOW_THRESHOLD, to be used to influence an uncore utilization point region to be used while in low utilization scenarios in which an ELC mode is active (in an embodiment, this threshold may be in terms of percentage of utilization of one or more of core or uncore, and may be set with, e.g., an 8-bit field); and (3) EFFICIENCY_LATENCY_CTRL_HIGH_THRESHOLD, to be used to indicate a utilization point above which uncore frequency (at least) is optimized (e.g., increased) to improve latency. In some cases, this frequency increase may be by a configurable amount, e.g., a policy configurable amount. In other cases, the frequency can be increased to a maximum level. In other embodiments, additional control parameters can be used, such as ratio and thresholds for core activity or memory.

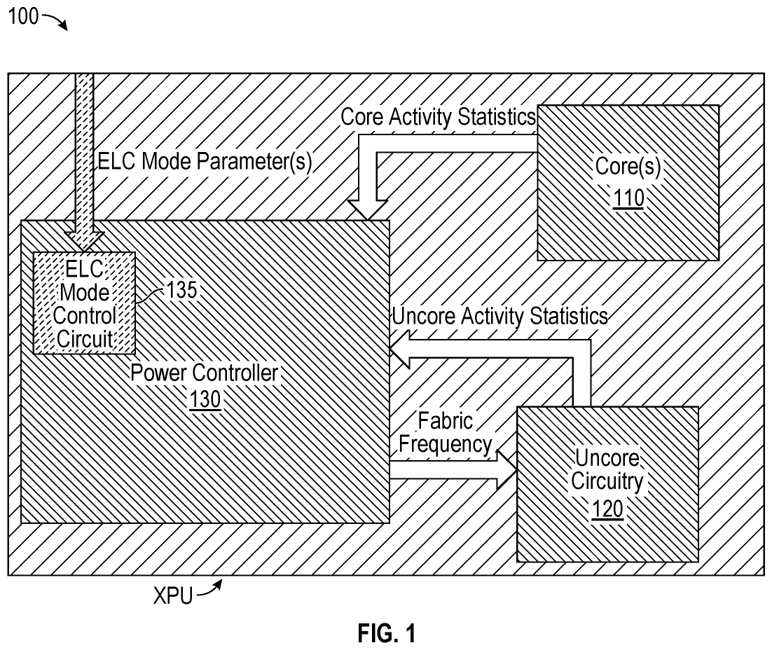

Referring now to FIG. 1, shown is a block diagram of a processor in accordance with an embodiment. As shown, processor 100 includes at least one core 110. Depending upon implementation there may be a plurality of cores. In some cases, these cores can be heterogeneous, such as a mix of lower power consuming, lower performant cores, also referred to as so-called efficiency cores (E-cores) and higher power consuming, higher performant cores, also referred to as so-called performance cores (P-cores). Understand that in one or more embodiments, processor 100 can be implemented as a processor socket including one or more semiconductor dies, e.g., one or more chiplets, each having cores or other processing circuitry, uncore circuitry, and so forth.

As further shown, processor 100 includes uncore circuitry 120. In general, uncore circuitry 120 may include various processor components external to cores 110, including interface circuitry, interconnect circuitry, fabric circuitry, controllers, input/output circuitry, memory controller circuitry and so forth. As used herein, understand that the terms “uncore,” and “interface circuitry” may be used interchangeably to refer to this core-external circuitry of a processor that performs non-processing operations.

With further reference to FIG. 1, processor 100 also includes a power controller 130. In various embodiments, power controller 130 may be implemented as a microcontroller (dedicated or general-purpose) or other control circuitry configured to execute its own dedicated power management code. As further shown, power controller 130 includes an ELC mode control circuit 135. In various embodiments, control circuit 135 may be configured to monitor utilization of processor 100 and, based at least in part on the utilization information and various configuration settings for ELC operation, identify when an ELC mode is to be activated. In addition, upon such identification, ELC mode control circuit 135 may configure various processor operating parameters to enable greater power savings in the ELC mode.

In the embodiment of FIG. 1, processor utilization may be monitored based at least in part on one or more of core activity statistics received from cores 110 and/or uncore activity statistics received from uncore circuitry 120. Although embodiments are not limited in this regard, in one or more implementations, these activity statistics may include active state residency information and so forth.

Still referring to FIG. 1, processor 100 includes an interface, which may be implemented as a MMIO interface to receive ELC parameters, which may be received from a given user. Depending upon use case, the user may be a fleet manager of a multi-tenant datacenter or, in the same multi-tenant datacenter context, the user may be a tenant of the datacenter that has a particular workload. In this way, a user that provides these ELC parameters has a full understanding of the workload to be executed on the multi-tenant datacenter.

Referring now to Table 1, shown are example, idle power savings that can be achieved in accordance with an embodiment on representative processors based on the choice of uncore frequency under Perf Idle conditions.

TABLE 1

| | | |
|---|---|---|
| | Example | Example |
| | Processor | Processor |
| ELC | SKU 1 | SKU 2 |

| Uncore | Random | | Random | |
|---|---|---|---|---|
| Freq | Idle | % | Idle | % |
| (at 0% | Memory | Drop | Memory | Drop |
| CPU | Latency | in Idle | Latency | in Idle |
| Util) | (ns) | Power | (ns) | Power |
| 2.4 | 100% | — | 100% | — |
| GHz | | | | |
| 2.0 | 106% | 19% | 103% | 13% |
| GHz | | | | |
| 1.6 | 111% | 29% | 112% | 23% |
| GHz | | | | |
| 1.2 | 126% | 34% | 125% | 31% |
| GHz | | | | |
| 800 | 156% | 39% | 155% | 35% |
| MHz | | | | |

In an embodiment, a minimum fabric frequency can be set to a P1 frequency level; however, higher power savings are possible at the cost of higher idle memory latency.

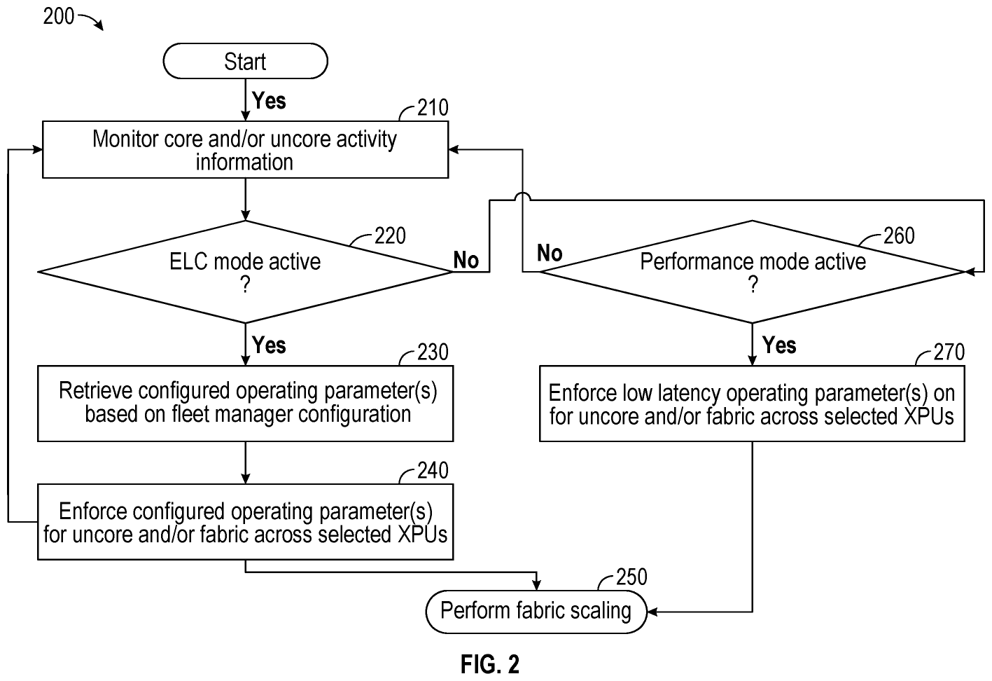

Referring now to FIG. 2, shown is a flow diagram of a method in accordance with an embodiment. More specifically, method 200 is a method for dynamic power control of a processor in accordance with an embodiment. As such, method 200 may be performed by hardware circuitry of the processor, such as a power controller alone and/or in combination with firmware and/or software.

In the embodiment of FIG. 2, method 200 may be used to dynamically and autonomously detect activity level based, e.g., on core and/or uncore statistics, to determine whether the processor is in a Perf Idle mode, and control one or more operating parameters such as uncore frequency based on the determination. Instead, when utilization is high, a low latency mode is detected and a higher frequency is dynamically set for the uncore circuitry.

As shown in FIG. 2, method 200 begins by monitoring core and/or uncore activity information (block 210). As an example, core activity information including C-states, P-states and/or residency counters can be monitored to determine core activity level. In turn, uncore activity information including mesh traffic metrics, hotspot information and so forth can be monitored to determine uncore activity level. Based at least in part on this monitoring, it can be determined at diamond 220 whether ELC mode is active. If so, control passes to block 230 where configured operating parameters for the ELC mode may be retrieved. More specifically, these ELC operating parameters which, in an embodiment may include an operating frequency for uncore circuitry and/or mesh interconnects, fabric interconnects or so forth, can be based on ELC configuration information such as described above. In an embodiment these parameters may be received via fleet manager configuration. Next at block 240, these configured operating parameters for the uncore and/or fabric can be enforced across one or more XPU's of a given system. Control next passes to block 250 where fabric scaling can also be performed. In this way, the fabric frequency is scaled as per the configured policies within the thresholds (or the threshold may be overridden (if policy permitted) during the runtime of the workload.

Still referring to FIG. 2, if the determination at diamond 220 is that an ELC mode is not to be activated, control passes to diamond 260 to determine whether a performance mode is active. In an embodiment, this determination may be based on a comparison of the monitored activity levels with respect to a high threshold identified by the fleet manager configuration, such as discussed above. If it is determined that a performance mode is to be activated, control passes to block 270 where low latency operating parameters are enforced on uncore and/or fabric across the selected XPU. These low latency operating parameters may include higher operating frequencies, to enable increased performance when the higher activity levels are detected. Note that if the performance mode is not indicated at diamond 260, control passes back to 210 for further monitoring of process for activity.

Although shown at this high level in the embodiment of FIG. 2, implementations can be extended to modulate settings of multiple domains of a processor, such as fabric frequency, interconnect link width, and/or memory power down modes. All of these features impact power savings and idle latency. For example, when an idle mode is detected, an interconnect can be dynamically adjusted to be placed into a L0p state, to reduce link width and thus saving link power at the cost of idle latency.

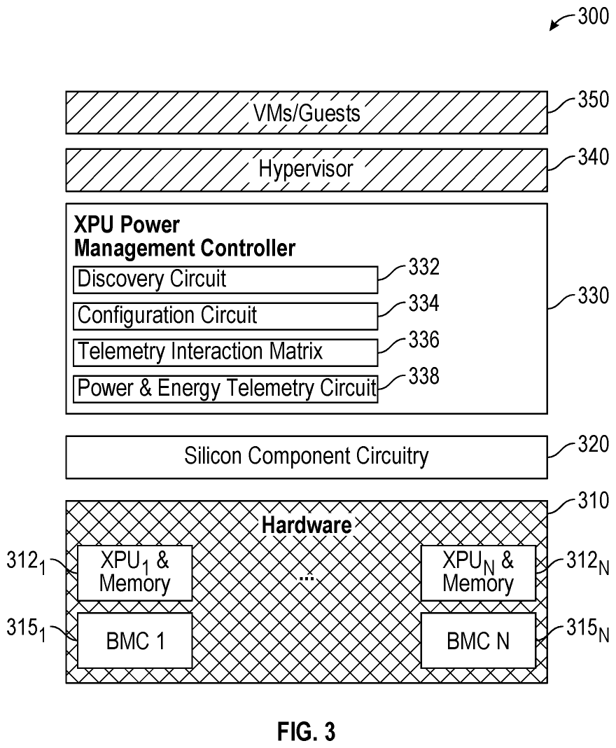

Referring now to FIG. 3, shown is a block diagram of a high-level system architecture which may be an IPU/XPU-centric datacenter with a controller in accordance with an embodiment. As shown in FIG. 3, a layered architecture is provided that may be implemented on one or more systems, such as a collection of servers of a datacenter. In the high level shown in FIG. 3, system hardware 300 includes various processors, memory and controllers. For example, a plurality of separate instances of at least one XPU and memory, such as may be implemented on a given motherboard, namely XPU/memory 312_{1-N} are illustrated. In an embodiment, the XPUs may be implemented as high-end server processors having a many core architecture, that in turn couple to system memory, e.g., implemented as hot pluggable dynamic random access memory (DRAM). As further illustrated, each XPU/memory 312_{1-N} may be associated with a baseboard management controller (BMC) 315_{1-N}. Understand that in a given system, additional hardware components, including non-volatile storage, fabric interconnect circuitry and so forth may be present.

Still referring to FIG. 3, between system hardware 310 and firmware/software layers, an XPU power management controller (PMC) 330 may be present. In various embodiments, PMC 330 may be implemented as a microcontroller (dedicated or general-purpose) or other control circuitry configured to execute its own dedicated power management code, sometimes referred to as P-code. As shown, PMC 330 includes constituent circuitry, including a discovery circuit 332, a configuration circuit 334, a telemetry interaction matrix 336, and a power and energy telemetry circuit 338, details of which are discussed below.

In turn, a hypervisor 340 executes on system 300 and may provide virtualization and other host support for multiple virtual machines (VMs)/guests 350. In embodiments, this software of VM/guest layer 350 may include workloads of many different tenants of a multi-tenant datacenter. For example, each VM/guest 350 may be of a given tenant and may include applications and other workloads of the tenant.

In one or more embodiments, configuration circuit 334 may be configured to provide a capability for, e.g., datacenters (such as fleet managers) to provide specific quality of service (QoS) profiles for particular tenant workloads. For example, for an example workload of a tenant having a given SLA, a QoS profile may include the following information: Performance @20% utilization of socket with a inter-processor interconnect at a low power (LP) state, QUAD sub-non-uniform memory architecture (NUMA) (SNC) configuration, and a junction temperature (Tj) of 87 degrees Celsius).

Discovery circuit 332 may be configured to provide a capability to identify the platform active idle configuration support continuously at various stages of platform lifecycle (idle—no utilization, management mode—minimal utilization, active core only utilization: 0-100%, active core+10 utilization: 0-100%), to dynamically determine an XPU affinity flow graph. In an embodiment, a telemetry matrix stores the telemetry information (e.g., platform topology, performance/power counters) from the XPU and interconnect, and a dependency on how they scale with respect to each other. Such information can be used for optimal fabric frequency scaling within thresholds and QoS criteria.

Power and energy telemetry circuit 338 may be configured with estimator, evaluator, controller and recommender functionality. In an embodiment, the estimator functionality may be configured to estimate power consumption from platform telemetry information across various XPU IP blocks for a given XPU affinity flow graph. In one implementation, the affinity flow graph may be specific for a given hardware configuration, tenant workload, and tenant ELC configuration settings.

In embodiments, a power management controller can implement a generative adversarial network (GAN) arrangement to identify optimized configuration settings with respect to efficiency latency control for specific particular tenant workloads. In contrast, typical datacenter environments do not have access to actual tenant workloads when considering optimizations such as described herein. Instead these conventional datacenter implementations use synthetic workloads that do not accurately represent actual workloads.

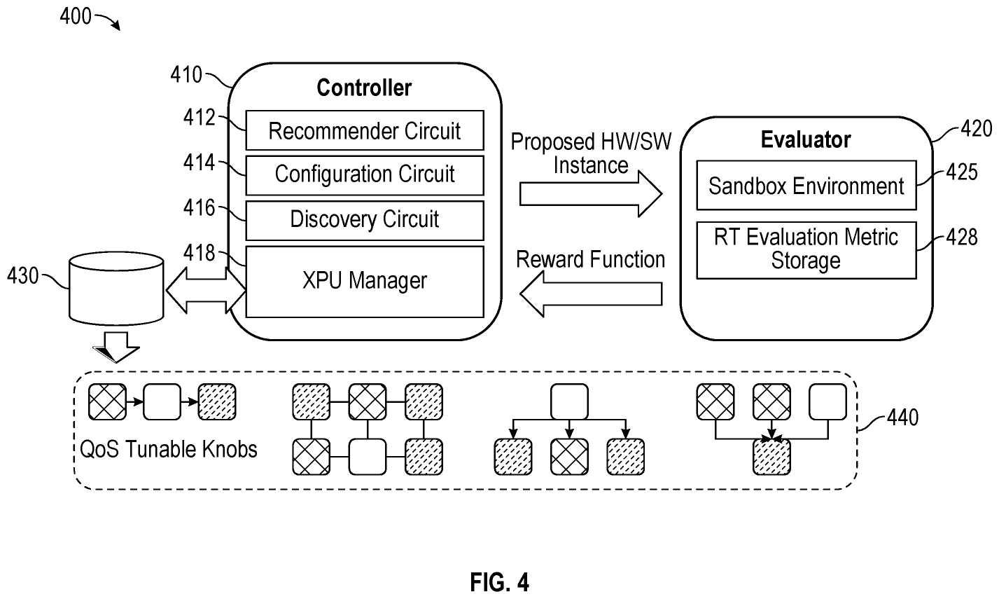

As illustrated in FIG. 4, a GAN 400 may be implemented with a controller 410 and an evaluator 420. Note that in various embodiments, both controller 410 and evaluator 420 may be implemented within a power management controller such as PMC 330. However, these different components are shown separately, as evaluator 420 is configured to execute on one or more processors of one or more servers, e.g., of a multi-tenant datacenter, while controller 410 may execute on this same hardware or separate hardware. In any event, as shown in FIG. 4, controller 410, via a recommender circuit 412 and a configuration circuit 414, may provide a proposed hardware/software instance to evaluator 420. This hardware/software instance may include an allocation of specific hardware such as one or more XPU's, fabrics, memory and so forth, along with a given software instance, such as an actual tenant workload (or portion thereof).

Evaluator 420 includes a sandbox environment 425, which may be a protected portion of datacenter hardware that is configured to run the proposed tenant workload, referred to herein as a sandbox workload. This is so, since the evaluation of execution of this tenant workload using proposed hardware and configuration settings may not be suitable for actual tenant execution, until the analysis described herein is performed. During execution of the proposed workload in sandbox environment 425, various real-time evaluation metrics including power, thermal, and performance metrics may be stored in a storage 428 of evaluator 420.

These real-time statistics may be provided after potentially some processing to an XPU manager 418 of controller 410. In various embodiments, these evaluation metrics may be processed to develop a reward function that is provided to XPU manager 418. From this information, XPU manager 418 may determine a set of operating parameters for the various hardware on which an actual tenant workload may execute. These operating parameters may include frequency, voltage and so forth for high latency and low latency modes. Different XPU profiles may be established, as illustrated in an inset 440, which is a representation of such information as may be stored in a database 430. As shown in inset 440, each collection of blocks corresponds to a set of QoS tunable knobs that may provide for different XPU profiles at a platform level. The different sets of blocks show interdependency based on power/thermal resiliency with placement strategy recommendations. The telemetry interaction matrix may be a function of an affinity flow graph that provides the interdependency of the modules (e.g., XPU, interconnect, and memory) and how they interact to derive optimal QoS knobs placement strategy (e.g., ordering) to have effective power/thermal/QoS.

In embodiments herein, database 430 may store such configuration information for a variety of different workloads for tenants of a multi-tenant datacenter. Although shown at this high level in the embodiment of FIG. 4, many variations and alternatives are possible.

In an embodiment, evaluator 420 may be configured to evaluate a new XPU affinity flow graph with a policy configured synthetic data generator to trace an activation profile of the hardware. Note that a synthetic data generator in accordance with an embodiment refers to the capability to generate simulated telemetry to evaluate “what-if” scenarios for a new XPU affinity flow graph. In an embodiment, this synthetic data generator can be implemented via a GAN artificial intelligence (AI) network. Controller 430 may be configured to monitor at runtime telemetry information to ensure that a recommended power profile is policed and monitored based on policy configuration. The recommender functionality may be configured to, based at least in part on one or more of a CPU affinity flow graph, past recommendations from database 430, and QoS profiles, generate a recommendation to provide the best profile configuration to be enforced.

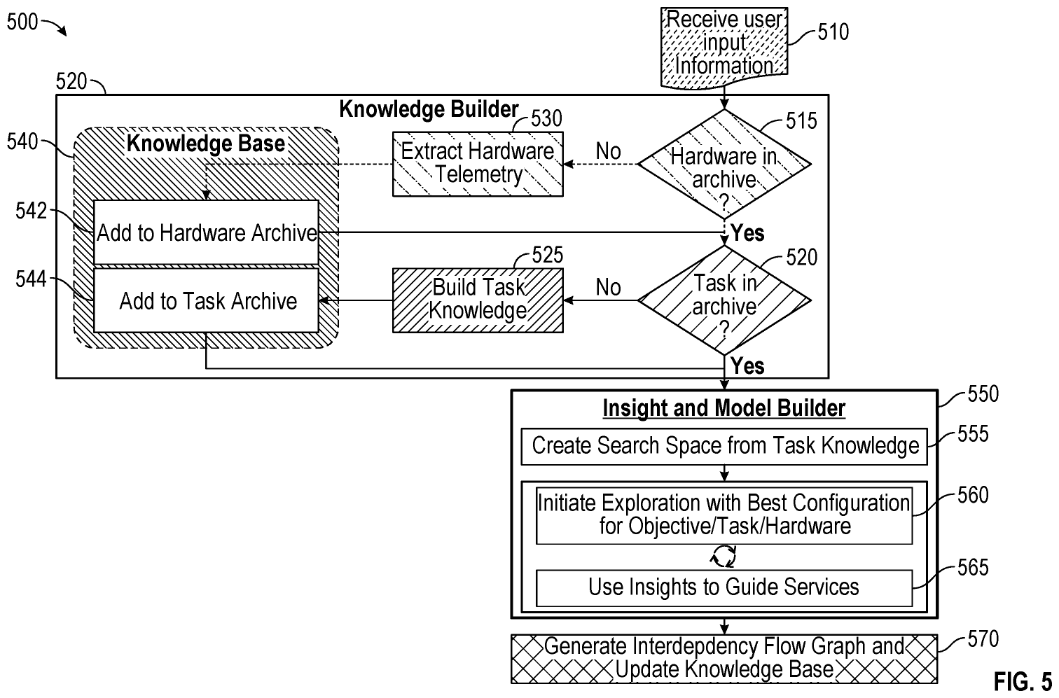

Referring now to FIG. 5, shown is a flow diagram of a method in accordance with another embodiment. As shown in FIG. 5, an operational flow of a knowledge base approach, where past learnt tunings can be saved and reused in certain cases, without going through a full tuning process.

More specifically, in method 500, a knowledge builder 520 such as implemented in a power management controller, GAN or other power management manager, may receive incoming user input information. Although embodiments are not limited in this regard, this user input information may include an objective, such as a given user's desire with respect to tradeoffs between power consumption and latency. This user input information may further include task information such as identification of a workload and its parameters and, potentially, target hardware, such as a user's desire for use of particular hardware and slash or configurations of such hardware.

In turn, a knowledge builder 520 operates to determine whether hardware and/or a task identified within the user input information is already archived, as determined at diamonds 515 and 520. If not, hardware telemetry may be extracted (block 530) and added to a hardware archive of a knowledge base 540, at block 542. Also if the task is not archived, at block 525, task knowledge may be built. This task knowledge is basically the affinity flow graph, telemetry interaction matrix and the resulting QoS configuration profile chosen for the current ingredients, that can be used for record keeping and future applications. A resulting task is added to a task archive at block 544.

Still referring to FIG. 5, once these operations occur, control passes to an insight and model builder 550 for various operations in determining appropriate operating parameters, based on the user input for the given workload. As illustrated, these operations include, at block 555 creating a search space from the task knowledge. Next at block 560, an exploration may be initiated to determine a best configuration for one or more of the user input criteria (objective, task and/or hardware). Such operations may be performed iteratively with block 565 in which the insights are used to guide services.

Finally, the resulting output of insight and model builder 515 may be in the form of an interdependency flow graph. This flow graph may be provided to the knowledgebase, e.g., knowledgebase 540 for inclusion. Although shown at this high level in the embodiment of FIG. 5, many variations and alternatives are possible.

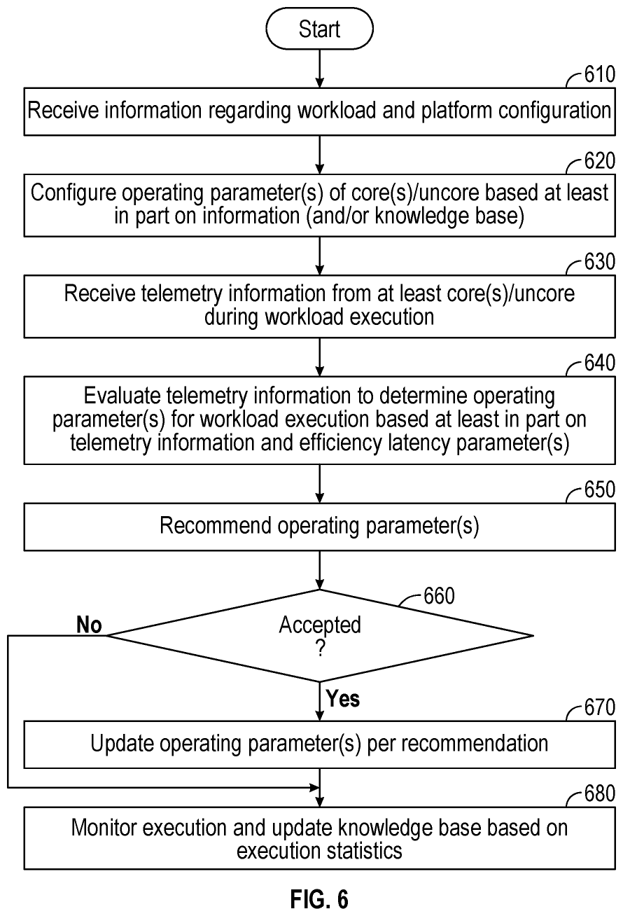

Referring now to FIG. 6, shown is a flow diagram of a method in accordance with yet another embodiment. As shown in FIG. 6, method 600 may be performed by hardware circuitry of one or more processors of a system, such as server PMC circuitry alone and/or in combination with firmware and/or software.

Method 600 begins by receiving information regarding a workload and a platform configuration (block 610). As an example, this information may be received from a given user, such as a datacenter tenant providing a workload and desired hardware on which it to execute. Next at block 620 one or more operating parameters of cores and/or uncore circuitry of one or more processors may be configured based at least in part on this information. Such parameters also may be configured based on information obtained from a knowledgebase, such as an entry within a knowledgebase that includes such operating parameters for a same or similar workload, e.g., of the same tenant.

Control next passes to block 630, where during operation of the workload, telemetry information may be received from at least the cores and/or the uncore. As discussed above, this telemetry information may include utilization information such as active state residency and so forth. At block 640, this telemetry information may be evaluated to determine one or more operating parameters for workload execution. In addition to the telemetry information, the evaluation may further proceed based on one or more ELC parameters such as described above, e.g., low and/or high thresholds, uncore frequency levels or so forth. Next at block 650, these operating parameters may be recommended, e.g., directly to the user via a user interface.

Still referring to FIG. 6, control next passes to diamond 660 to determine whether these recommendations are accepted. If so, one or more operating parameters may be updated per the recommendation (block 670). Finally, at block 680 execution of the workload with these operating parameters may be monitored. Still further, the knowledgebase can be updated based on execution statistics obtained during the execution. Although shown at this high level in the embodiment of FIG. 6, many variations and alternatives are possible.

With embodiments, a processor-based system can be configured to operate in a more power efficient manner and improve a TCO. For example, embodiments may provide significant power savings in low utilization scenarios (e.g., approximately 30%). The power savings during low utilization scenarios aid in reducing cooling costs, and can further reduce operating expense costs for a datacenter.

In addition, users, via one or more ELC parameters, can tune an idle latency vs. power savings tradeoff to meet idle power and energy efficiency targets. These targets may be set at both a platform level and can be scaled to fleet level, in the case of a datacenter.

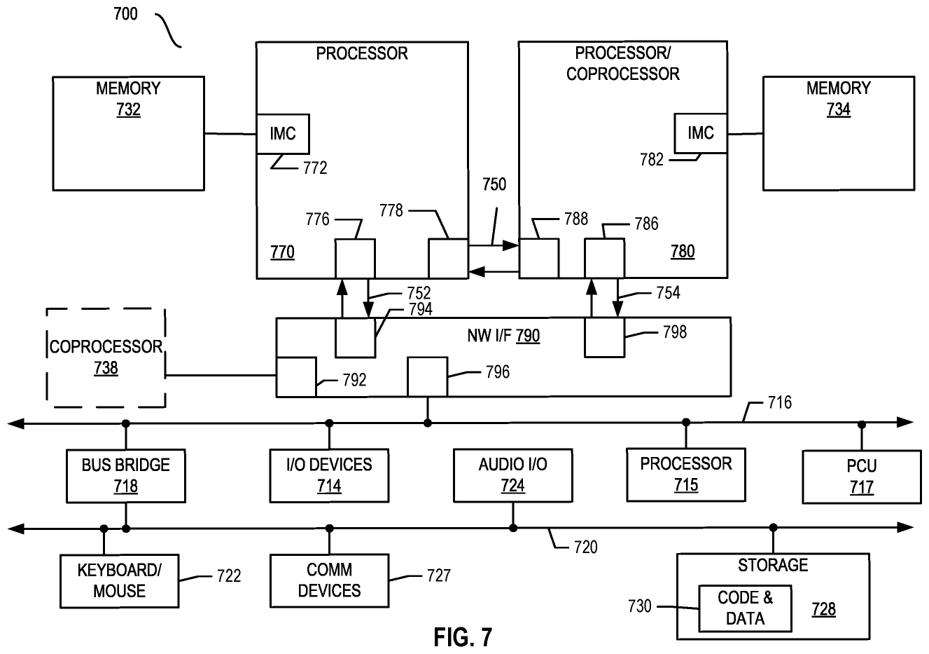

FIG. 7 illustrates an example computing system. Multiprocessor system 700 is an interfaced system and includes a plurality of processors or cores including a first processor 770 and a second processor 780 coupled via an interface 750 such as a point-to-point (P-P) interconnect, a fabric, and/or bus. In some examples, the first processor 770 and the second processor 780 are homogeneous. In some examples, first processor 770 and the second processor 780 are heterogenous. Though the example system 700 is shown to have two processors, the system may have three or more processors, or may be a single processor system. In some examples, the computing system is a SoC. In any event, system 700 may be of a datacenter and can implement embodiments to determine a tradeoff between power efficiency and latency of workloads, such as tenant workloads in a multi-tenant datacenter as described herein.

Processors 770 and 780 are shown including integrated memory controller (IMC) circuitry 772 and 782, respectively. Processor 770 also includes interface circuits 776 and 778; similarly, second processor 780 includes interface circuits 786 and 788. Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a network interface (NW I/F) 790 via individual interfaces 752, 754 using interface circuits 776, 794, 786, 798. The network interface 790 (e.g., one or more of an interconnect, bus, and/or fabric, and in some examples is a chipset) may optionally exchange information with a coprocessor 738 via an interface circuit 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via an interface such as P-P interconnect, such that either or both processors' local cache information may be stored in the shared cache if a processor is placed into a low power mode.

Network interface 790 may be coupled to a first interface 716 via interface circuit 796. In some examples, first interface 716 may be an interface such as a Peripheral Component Interconnect (PCI) interconnect, a PCI Express interconnect or another I/O interconnect. In some examples, first interface 716 is coupled to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interface 716, along with a bus bridge 718 which couples first interface 716 to a second interface 720. In some examples, one or more additional processor(s) 715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730. Further, an audio 1/O 724 may be coupled to second interface 720. Note that other architectures than the point-to-point architecture described above are possible. For example, instead of the point-to-point architecture, a system such as multiprocessor system 700 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

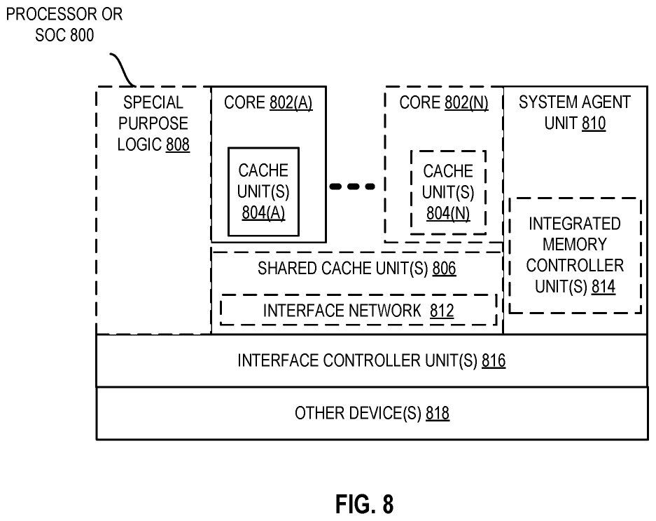

FIG. 8 illustrates a block diagram of an example processor and/or SoC 800 that may have one or more cores and an integrated memory controller. The solid lined boxes illustrate a processor 800 with a single core 802(A), system agent unit circuitry 810, and a set of one or more interface controller unit(s) circuitry 816, while the optional addition of the dashed lined boxes illustrates an alternative processor 800 with multiple cores 802(A)-(N), a set of one or more integrated memory controller unit(s) circuitry 814 in the system agent unit circuitry 810, and special purpose logic 808, as well as a set of one or more interface controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802(A)-(N) being one or more general purpose cores (e.g., general purpose in-order cores, general purpose out-of-order cores, or a combination of the two); 2) a coprocessor with the cores 802(A)-(N) being a large number of special purpose cores intended primarily for graphics and/or scientific (throughput); and 3) a coprocessor with the cores 802(A)-(N) being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples interface network circuitry 812 (e.g., a ring interconnect) interfaces the special purpose logic 808 (e.g., integrated graphics logic), the set of shared cache unit(s) circuitry 806, and the system agent unit circuitry 810, alternative examples use any number of well-known techniques for interfacing such units. In some examples, coherency is maintained between one or more of the shared cache unit(s) circuitry 806 and cores 802(A)-(N). In some examples, interface controller units circuitry 816 couple the cores 802 to one or more other devices 818 such as one or more I/O devices, storage, one or more communication devices (e.g., wireless networking, wired networking, etc.), etc.

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The display unit circuitry is for driving one or more externally connected displays. In various embodiments, cores 802 may include performance counters and other telemetry circuitry to maintain activity statistics that may be used in determining optimized operating parameters as described herein.

The cores 802(A)-(N) may be homogenous in terms of instruction set architecture (ISA). Alternatively, the cores 802(A)-(N) may be heterogeneous in terms of ISA; that is, a subset of the cores 802(A)-(N) may be capable of executing an ISA, while other cores may be capable of executing only a subset of that ISA or another ISA.

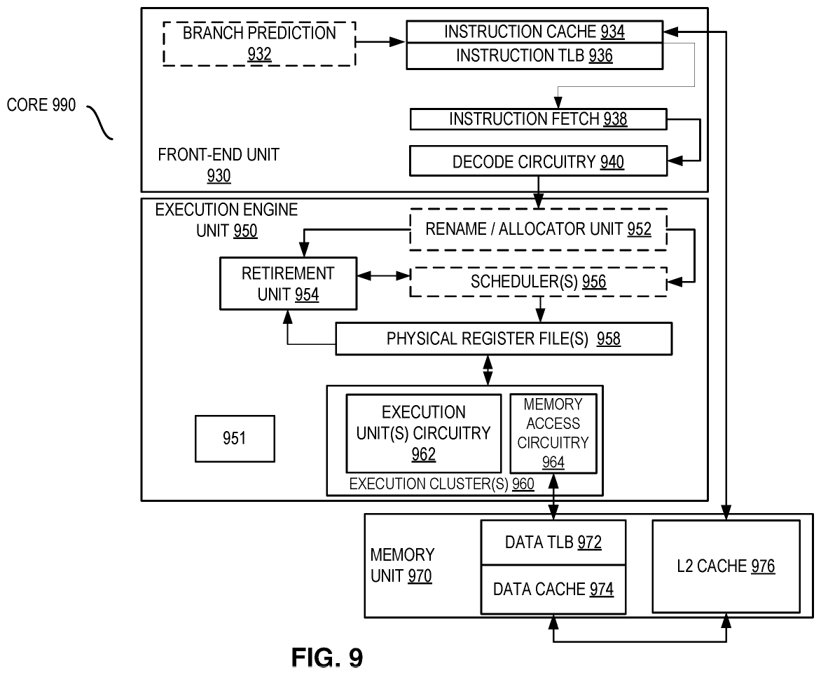

FIG. 9 shows a processor core 990 including front-end unit circuitry 930 coupled to execution engine unit circuitry 950, and both are coupled to memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front-end unit circuitry 930 may include branch prediction circuitry 932 coupled to instruction cache circuitry 934, which is coupled to an instruction translation lookaside buffer (TLB) 936, which is coupled to instruction fetch circuitry 938, which is coupled to decode circuitry 940. In one example, the instruction cache circuitry 934 is included in the memory unit circuitry 970 rather than the front-end circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In one example, the core 990 includes a microcode ROM (not shown) or other medium that stores microcode for certain macroinstructions (e.g., in decode circuitry 940 or otherwise within the front-end circuitry 930). In one example, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine circuitry 950.

The execution engine circuitry 950 includes the rename/allocator unit circuitry 952 coupled to retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, address generation unit (AGU) scheduler/scheduling circuitry, AGU queues, etc. As shown, the execution engine circuitry 950 may include telemetry circuitry 951 to maintain activity and other performance statistics that may be used in determining optimized operating parameters as described herein.

The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to data cache circuitry 974 coupled to level 2 (L2) cache circuitry 976. In one example, the memory access circuitry 964 may include load unit circuitry, store address unit circuitry, and store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In one example, the instruction cache 934 and the data cache 974 are combined into a single instruction and data cache (not shown) in L2 cache circuitry 976, level 3 (L3) cache circuitry (not shown), and/or main memory. The L2 cache circuitry 976 is coupled to one or more other levels of cache and eventually to a main memory.

The following examples pertain to further embodiments.

In one example, an apparatus includes: at least one core to execute instructions; an interface circuit coupled to the at least one core to perform non-processing operations and interface with one or more platform components; and a power controller coupled to the least one core and the interface circuit. The power controller is to receive at least one efficiency latency parameter to optimize a power-latency tradeoff and control a frequency of the interface circuit based at least in part on an activity level of the at least one core and the at least one efficiency latency parameter.

In an example, the at least one efficiency latency parameter comprises a low threshold, the power controller to reduce the frequency of the interface circuit responsive to the activity level of at least one of the at least one core or the frequency of the interface circuit being less than the low threshold.

In an example, responsive to the activity level of the at least one core exceeding the low threshold, the power controller is to control the frequency of the interface circuit with dynamic voltage and frequency scaling.

In an example, the at least one efficiency latency parameter further comprises a high threshold, the power controller to increase the frequency of the interface circuit by a configurable amount responsive to the activity level of the at least one core exceeding the high threshold.

In an example, the at least one efficiency latency parameter comprises a tuning parameter to be adjusted by a datacenter tenant based at least in part on a workload of the datacenter tenant.

In an example, the apparatus further comprises a controller to identify a configuration of a platform comprising the apparatus and the one or more platform components, the one or more platform components comprising memory and non-volatile storage, the apparatus comprising a processor socket.

In an example, the controller is to: receive information regarding a sandbox workload to execute in a sandbox environment on the platform, the sandbox workload comprising a workload of a datacenter tenant and the sandbox environment comprising a protected domain in which to execute the sandbox workload for evaluation purposes; configure one or more operating parameters of the at least one core and the interface circuit for execution of the sandbox workload in the sandbox environment and cause the execution of the sandbox workload in the sandbox environment; and receive telemetry information from at least one of the at least one core or the interface circuit during execution of the sandbox workload in the sandbox environment.

In an example, the controller is to evaluate the telemetry information to determine one or more recommended operating parameters of the apparatus for use during execution of the workload outside of the sandbox environment on one or more platforms.

In an example, the controller is to store in a database a knowledgebase entry for the sandbox workload, the knowledgebase entry comprising the recommended one or more parameters.

In an example, the controller is to provide at least a portion of the knowledgebase entry to the one or more platforms to cause the one or more platforms to execute at least a portion of the workload outside of the sandbox environment using the one or more recommended operating parameters.

In an example, the interface circuit comprises the power controller and an uncore.

In another example, a method comprises: determining a configuration of a platform, the configuration comprising an identification of a plurality of processors, a memory configuration, a storage configuration, and a fabric configuration of the platform; receiving information regarding a sandbox workload for execution in a sandbox environment on the platform, the sandbox workload comprising a workload of a datacenter tenant and the sandbox environment comprising a protected domain in which to execute the sandbox workload for evaluation purposes; configuring one or more operating parameters for at least one processor of the plurality of processors for execution of the sandbox workload in the sandbox environment and causing the execution of the sandbox workload in the sandbox environment; receiving telemetry information from the at least one processor during execution of the sandbox workload in the sandbox environment; and evaluating the telemetry information to determine one or more recommended operating parameters for the at least one processor for use during execution of the workload outside of the sandbox environment.

In an example, the method further comprises determining the one or more recommended operating parameters for the at least one processor based at least in part on the telemetry information and an efficiency latency parameter obtained from a tenant having the sandbox workload, the efficiency latency parameter to optimize a power-latency tradeoff.

In an example, the method further comprises: providing the one or more recommended operating parameters to the datacenter tenant; receiving an approval of the one or more recommended operating parameters from the datacenter tenant; and in response to the approval, configuring the plurality of processors with the one or more recommended operating parameters for execution of the workload outside of the sandbox environment on at least the platform.

In an example, the method further comprises: monitoring the execution of the workload outside of the sandbox environment; and updating, in a database, an entry associated with the workload based on the monitoring.

In an example, the monitoring comprises monitoring execution statistics of the workload, the execution statistics comprising an activity level of one or more first cores of at least one processor of the plurality of processors and an activity level of an interface circuit of the at least one processor, and the method further comprises: evaluating the one or more recommended operating parameters based on the execution statistics; and in response to the evaluating, recommending one or more updated operating parameters.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In yet another example, a system includes: a plurality of processors, at least one of the plurality of processors comprising: at least one core to execute instructions; an interface circuit coupled to the at least one core to perform non-processing operations and interface with platform components of the system; and a power controller coupled to the least one core and the interface circuit, wherein the power controller is to receive at least one efficiency latency parameter to optimize a power-latency tradeoff and control a frequency of the interface circuit based at least in part on an activity level of the at least one core and the at least one efficiency latency parameter, a value of the at least one efficiency latency parameter associated with a workload of a tenant of the system. The platform components may include: memory coupled to the plurality of processors, at least some of the memory comprising hot pluggable memory; and non-volatile storage coupled to the memory, the non-volatile storage to store the workload of the tenant of the system.

In an example, the non-volatile storage further comprises instructions that when executed by system cause the system to: receive telemetry information from the at least one processor during execution of the workload; evaluate the telemetry information to determine one or more recommended operating parameters for the at least one processor; and provide to the tenant a recommendation regarding the one or more recommended operating parameters, based at least in part on the evaluation of the telemetry information.

In an example, the non-volatile storage further comprises instructions that when executed by the system cause the system to: monitor execution statistics of the workload, the execution statistics comprising an activity level of the at least one core; and based at least in part on the execution statistics, provide a second recommendation regarding an update to the one or more recommended operating parameters.

In an example, the non-volatile storage further comprises instructions that when executed by the system cause the system to execute a generative adversarial network to evaluate a sandbox workload and determine a plurality of operating parameters for the plurality of processors based at least in part on an efficiency latency parameter to optimize a power-latency tradeoff, the efficiency latency parameter provided by the tenant, the sandbox workload comprising at least a portion of the workload to execute in a sandbox environment comprising a protected domain in which to execute the sandbox workload for evaluation by the generative adversarial network.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SOC or other processor, is to configure the SOC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
at least one core to execute instructions;
an interface circuit coupled to the at least one core to perform non-processing operations and interface with one or more platform components; and
a power controller coupled to the least one core and the interface circuit, wherein the power controller is to receive at least one efficiency latency parameter to optimize a power-latency tradeoff and control a frequency of the interface circuit based at least in part on an activity level of the at least one core and the at least one efficiency latency parameter.

2. The apparatus of claim 1, wherein the at least one efficiency latency parameter comprises a low threshold, the power controller to reduce the frequency of the interface circuit responsive to the activity level of at least one of the at least one core or the frequency of the interface circuit being less than the low threshold.

3. The apparatus of claim 2, wherein responsive to the activity level of the at least one core exceeding the low threshold, the power controller is to control the frequency of the interface circuit with dynamic voltage and frequency scaling.

4. The apparatus of claim 3, wherein the at least one efficiency latency parameter further comprises a high threshold, the power controller to increase the frequency of the interface circuit by a configurable amount responsive to the activity level of the at least one core exceeding the high threshold.

5. The apparatus of claim 1, wherein the at least one efficiency latency parameter comprises a tuning parameter to be adjusted by a datacenter tenant based at least in part on a workload of the datacenter tenant.

6. The apparatus of claim 1, further comprising a controller to identify a configuration of a platform comprising the apparatus and the one or more platform components, the one or more platform components comprising memory and non-volatile storage, the apparatus comprising a processor socket.

7. The apparatus of claim 6, wherein the controller is to:
receive information regarding a sandbox workload to execute in a sandbox environment on the platform, the sandbox workload comprising a workload of a datacenter tenant and the sandbox environment comprising a protected domain in which to execute the sandbox workload for evaluation purposes;
configure one or more operating parameters of the at least one core and the interface circuit for execution of the sandbox workload in the sandbox environment and cause the execution of the sandbox workload in the sandbox environment; and
receive telemetry information from at least one of the at least one core or the interface circuit during execution of the sandbox workload in the sandbox environment.

8. The apparatus of claim 7, wherein the controller is to evaluate the telemetry information to determine one or more recommended operating parameters of the apparatus for use during execution of the workload outside of the sandbox environment on one or more platforms.

9. The apparatus of claim 8, wherein the controller is to store in a database a knowledgebase entry for the sandbox workload, the knowledgebase entry comprising the recommended one or more parameters.

10. The apparatus of claim 9, wherein the controller is to provide at least a portion of the knowledgebase entry to the one or more platforms to cause the one or more platforms to execute at least a portion of the workload outside of the sandbox environment using the one or more recommended operating parameters.

11. The apparatus of claim 1, wherein the interface circuit comprises the power controller and an uncore.

12. At least one computer readable medium comprising instructions that, when executed by a processor, cause the processor to perform a method comprising:
determining a configuration of a platform, the configuration comprising an identification of a plurality of processors, a memory configuration, a storage configuration, and a fabric configuration of the platform;
receiving information regarding a sandbox workload for execution in a sandbox environment on the platform, the sandbox workload comprising a workload of a datacenter tenant and the sandbox environment comprising a protected domain in which to execute the sandbox workload for evaluation purposes;
configuring one or more operating parameters for at least one processor of the plurality of processors for execution of the sandbox workload in the sandbox environment and causing the execution of the sandbox workload in the sandbox environment;
receiving telemetry information from the at least one processor during execution of the sandbox workload in the sandbox environment; and
evaluating the telemetry information to determine one or more recommended operating parameters for the at least one processor for use during execution of the workload outside of the sandbox environment.

13. The at least one computer readable medium of claim 12, wherein the method further comprises determining the one or more recommended operating parameters for the at least one processor based at least in part on the telemetry information and an efficiency latency parameter obtained from a tenant having the sandbox workload, the efficiency latency parameter to optimize a power-latency tradeoff.

14. The at least one computer readable medium of claim 12, wherein the method further comprises:
providing the one or more recommended operating parameters to the datacenter tenant;
receiving an approval of the one or more recommended operating parameters from the datacenter tenant; and
in response to the approval, configuring the plurality of processors with the one or more recommended operating parameters for execution of the workload outside of the sandbox environment on at least the platform.

15. The at least one computer readable medium of claim 14, wherein the method further comprises:
monitoring the execution of the workload outside of the sandbox environment; and
updating, in a database, an entry associated with the workload based on the monitoring.

16. The at least one computer readable medium of claim 15, wherein the monitoring comprises monitoring execution statistics of the workload, the execution statistics comprising an activity level of one or more first cores of at least one processor of the plurality of processors and an activity level of an interface circuit of the at least one processor, and the method further comprises:
evaluating the one or more recommended operating parameters based on the execution statistics; and
in response to the evaluating, recommending one or more updated operating parameters.

17. A system comprising:
a plurality of processors, at least one of the plurality of processors comprising:
at least one core to execute instructions;
an interface circuit coupled to the at least one core to perform non-processing operations and interface with platform components of the system; and
a power controller coupled to the least one core and the interface circuit, wherein the power controller is to receive at least one efficiency latency parameter to optimize a power-latency tradeoff and control a frequency of the interface circuit based at least in part on an activity level of the at least one core and the at least one efficiency latency parameter, a value of the at least one efficiency latency parameter associated with a workload of a tenant of the system; and
the platform components comprising:
memory coupled to the plurality of processors, at least some of the memory comprising hot pluggable memory; and
non-volatile storage coupled to the memory, the non-volatile storage to store the workload of the tenant of the system.

18. The system of claim 17, wherein the non-volatile storage further comprises instructions that when executed by system cause the system to:
receive telemetry information from the at least one processor during execution of the workload;
evaluate the telemetry information to determine one or more recommended operating parameters for the at least one processor; and
provide to the tenant a recommendation regarding the one or more recommended operating parameters, based at least in part on the evaluation of the telemetry information.

19. The system of claim 18, wherein the non-volatile storage further comprises instructions that when executed by the system cause the system to:
monitor execution statistics of the workload, the execution statistics comprising an activity level of the at least one core; and
based at least in part on the execution statistics, provide a second recommendation regarding an update to the one or more recommended operating parameters.

20. The system of claim 17, wherein the non-volatile storage further comprises instructions that when executed by the system cause the system to execute a generative adversarial network to evaluate a sandbox workload and determine a plurality of operating parameters for the plurality of processors based at least in part on an efficiency latency parameter to optimize a power-latency tradeoff, the efficiency latency parameter provided by the tenant, the sandbox workload comprising at least a portion of the workload to execute in a sandbox environment comprising a protected domain in which to execute the sandbox workload for evaluation by the generative adversarial network.
